(19) United States
(12) Patent Application Publication
(10) Pub. No.: US 2008/0141265 A1
(43) Pub. Date: Jun. 12, 2008

(54) Power Management Method for Platform and that Platform

(75) Inventor: Seung-Min Choi, Daejeon-city (KR)

Correspondence Address: LOWE HAUPTMAN HAM & BERNER, LLP, 1700 DIAGONAL ROAD, SUITE 300, ALEXANDRIA, VA, 22314, US

(73) Assignee: ELECTRONICS AND TELECOMMUNICATIONS RESEARCH INSTIT, DAEJEON-CITY (KR)

(21) Appl. No.: 11/720,095

(22) PCT Filed: Feb. 1, 2005
(86) PCT No.: PCT/KR2005/000301

§ 371 Date: May 24, 2007

(30) Foreign Application Priority Data
Dec. 8, 2004 (KR) 10-2004-0103023

(51) Int. Cl. G06F 9/46

(52) U.S. Cl. 718/105

(57) ABSTRACT

A method for power management of a platform by scheduling a job, which is a set of instructions for completion of a task, given to a device, the method including a) when a given event occurs, analyzing the event according to workloads, b) calculating a scheduling period of a job performed on the corresponding device in consideration of a time constraint, the size of a memory for buffering the job, and energy consumption for the buffering according to workloads of the job, and c) changing a power state of each device according to a job schedule calculated in b).

### TECHNICAL FIELD

The present invention relates to a platform and a method for power management of the platform. More particularly, the present invention relates to a method for power management of a platform by doing job scheduling of the platform.

### BACKGROUND ART

A platform, particularly a mobile platform, is supplied power from a battery and provides various functions while supporting mobility.

However, energy supplied from a battery is not sufficient for operations of the mobile platform due to a limited battery capacity. Therefore, it is important to maximize the battery capacity and to develop an efficient power management method in platform design.

System-level power management may be implemented through several levels, and operating system—(OS) level power management is particularly effective for interactive systems, for example, a mobile platform. Thus, various system-level power management algorithms are applied to the mobile platform.

For instance, a predictive algorithm is used to determine shut-down time of a device by predicting an idle period of devices in a system. At this point, information on the start of the next idle period of the device is predicted by evaluating a history of device usage patterns. Hence, system performance and energy saving efficiency change depending on prediction accuracy.

In addition, job scheduling, used to schedule a set of instructions (hereinafter, referred to as a “job”) for completing a specific task of a platform, makes an idle period of an inactive device or a central processing unit (CPU) such that chances for shutting down increase. At this point, a current job may occupy the device, and a processing order of the job is set by a kernel scheduler. Thus, an operation use time period of the device may be changed depending on the scheduling method used. In other words, scheduling a job which needs a device directly affects the length of an idle period of the device, and therefore, the chance of shutting down is increased by making the idle periods of the device as consecutive as possible.

However, a job may be scheduled by a burst scheduling method or a split scheduling method depending on variations in workloads of a device, and therefore, power management efficiency may be correspondingly changed. In addition, since the size of a buffer available for a scheduling process may change during execution of a system according to a condition of the system, the size of a currently available buffer needs to be considered so as to save energy without degrading system performance. A time constraint (deadline) also needs to be considered because a job processing order may be changed due to job scheduling and thus the job it may not be completed within a user desired deadline.

However, the above-mentioned conventional methods cannot provide efficient power management since they do not take account of a workload of a job, memory capacity available for buffering, and a time delay due to the buffering process. Further, when a job is executed based on a burst period, energy consumed by a job queue may offset energy saved by the burst scheduling.

The above information disclosed in this Background of the Invention section is only for enhancement of understanding of the background of the invention, and therefore it should not be understood that all the above information forms the prior art that is already known in this country to a person or ordinary skill in the art.

### DISCLOSURE

### Technical Problem

The present invention has been made in an effort to provide a power management method having advantages of considering workloads of a job, the size of a memory for buffering of the job, and time delay and energy consumption for the buffering, to thereby save energy without degrading system performance.

### Technical Solution

In one aspect of the present invention, there is provided a method for power management of a platform by scheduling a job given to a device, wherein the job is a set of instructions for completion of a task. The method includes a) when a given event occurs, analyzing the event according to workloads; b) calculating a scheduling period of a job performed on the corresponding device in consideration of a time constraint, the size of a memory for buffering the job, and energy consumption for the buffering according to workloads of the job; and c) changing a power state of each device according to a job schedule calculated in b).

In b), the scheduling period may be calculated in consideration of at least one of a first period which is restricted by the memory size and a second period which is restricted by the time constraint.

In another aspect of the present invention, there is provided a platform managing power consumption by scheduling a job, which is a unit allocated to a device for completion of a task. The platform includes an application unit and an operation system. The application unit generates a given event. The operating system obtains an optimal scheduling period in consideration of at least one of a time constraint, a memory constraint, and energy consumed for buffering the job according to workloads of the job, and changes a power state of the corresponding device when receiving information on the generation of the event.

The operating system includes a process manager, a scheduler, a device driver, and a power manager. The process manager receives information on generation of a task, monitors and manages a current task, and transmits information on a task state. The scheduler schedules the job according to a scheduled period. The device driver controls driving of a device on which the job is executed. The power manager obtains an optimal scheduling period in consideration of at least one of a time constraint, a memory constraint, and energy consumed for the buffering according to workloads, and controls the device driver to change a power state of the corresponding device based on information on a task state transmitted from the process manager and a job schedule transmitted from the scheduler.

### ADVANTAGEOUS EFFECTS

According to the embodiments of the present invention, in OS-level power management of a platform, particularly a mobile platform, an optimal job scheduling period is calculated in consideration of workloads of a job, the size of a memory and time delay for buffering the job, and the amount of energy consumed for the buffering. Accordingly, energy saving can be achieved without degrading system performance.

### DESCRIPTION OF DRAWINGS

FIG. 1 illustrates a power state of a device based on the variations of workloads according to an embodiment of the present invention.

FIG. 2 and FIG. 3 show power consumption of a device in an idle state in two cases: maintaining a power state of the device in the idle working state, and shutting down the device, according to an embodiment of the present invention.

FIG. 4 shows wireless local area network (WLAN) call patterns and power states depending on a scheduling method according to an embodiment of the present invention.

FIG. 5 is a graph for selection an optimal burst period T for power saving according to a data rate value S according to an embodiment of the present invention.

FIG. 6 and FIG. 7 are three-dimensional graphs illustrating energy consumption of each device according to a split scheduling method and a burst scheduling method according to an embodiment of the present invention.

FIG. 8 exemplarily shows a configuration of a platform managing power consumption by scheduling jobs according to an embodiment of the present invention.

FIG. 9 is a flowchart of a power management method through job scheduling according to an embodiment of the present invention.

FIG. 10 exemplarily shows a pseudo code implemented to calculate a burst period for job scheduling in the power management method according to an embodiment of the present invention.

### BEST MODE

An embodiment of the present invention will hereinafter be described in detail with reference to the accompanying drawings.

The following table defines symbols used throughout the specification.

TABLE
Symbol definitions

| Symbol | Meaning |
|---|---|
| t_{sd} (t_{wu}) | Shutdown (wakeup) delay |
| tₒ | State transition delay (t_{sd} + T_{wu}) |
| t_{be, k} | Break-even time of device dₖ |
| Tᵤ | Burst period of job that needs a device for Task ᵤ |
| P_{iw} (Pₛ) | Power consumption in idle working (sleeping) state |
| P_{iw, k} (P_{s, k}) | Power consumption in idle working (sleeping) state of |
| | device dₖ |
| P_{bw, k} | Power consumption in busy working state of device dₖ |
| P_{nKbuf} | Power consumption of n Kbyte buffer memory |
| e_{sd} (e_{wu}) | Shutdown (wakeup) energy |
| eₒ | State transition energy (e_{sd} + e_{wu}) |
| Eₛₚₗᵢₜ | Energy consumption when processing immediately upon |
| | request |
| E_{burst} | Energy consumption during burst process upon request |
| E_{Buf} | Buffer memory energy |
| BWₖ | Data processing performance of device (bps, fps, etc.) |
| S_{k, u} | Data size processed by device upon request of Taskᵤ |
| | (Byte) |
| N_{k, u} | Number of requests of Taskᵤ for S size data per second |

Each case of calculating a period is defined as an event, and this means conditions for calling an equation for calculating a period T. The types of event are as follows:

(1) Add tasks to run queue

(2) Remove tasks from run queue

(3) Time constraint change

(4) Memory constraint change

(5) Task's S*N change

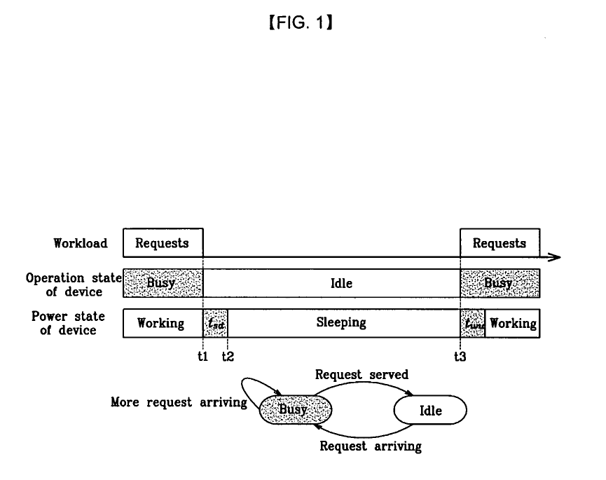

FIG. 1 illustrates a process of waking up a sleeping device or putting the device into a sleeping state depending on variations of workloads.

As shown in FIG. 1, when there are requests to serve, the device is busy. Otherwise, the device is idle. In FIG. 1, the device is idle between t₁ and t₃|, and the device may be put into a sleeping state during this idle period for power management. Power state transition requires shutdown delay t_{sd} and wake-up delay t_{wd}, and also consumes extra energy. Therefore, a substantial energy gain is achieved by putting the device into a sleeping state when the device is idle longer than a predetermined time. A break-even time t_{be}, a unique characteristic constant of a device, is the minimum length of an idle period to save power by shutting down the device.

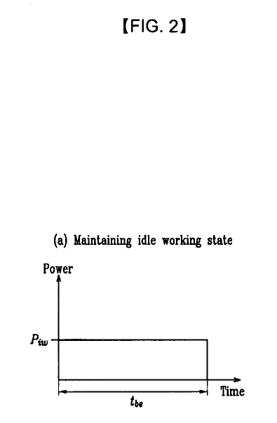

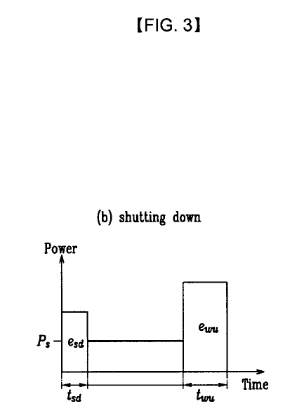

FIG. 2 and FIG. 3 illustrate power consumption in two cases: keeping the device in the idle working state or shutting it down.

At this point, t_{be} denotes time when an amount of energy consumed for keeping the device in the idle working state (shown in FIG. 2) and an amount of energy consumed for shutting down (shown in FIG. 3) become equal. Suppose power consumption of the device in the idle working and sleeping states are

$${P}_{iw} and \overline{{P}_{s}} ( {P}_{iw} >= {\overline{P}}_{s} ) ,$$

respectively, and a state-transition delay is t̅ₒ̅ and the transition energy is e̅ₒ̅ for shutting down and waking up the device. Then, a value of

$${t}_{be}$$

is calculated as follows.

$${p}_{iw} \times {t}_{be} = {e}_{0} + {p}_{s} \times ( {t}_{be} - {t}_{o} ) ; {t}_{be} > {t}_{o} \\ {t}_{be} = max ( \frac{{e}_{o} - {p}_{s} \times {t}_{o}}{{p}_{iw} - {p}_{s}} , {t}_{o} ) \qquad ( 1 )$$

That is, the break-even time t_{be} depends on the device and is independent on requests or power management policies. To achieve energy gain by shutting down the device, the device should be maintained in the idle state for a longer period of time than the break-even time.

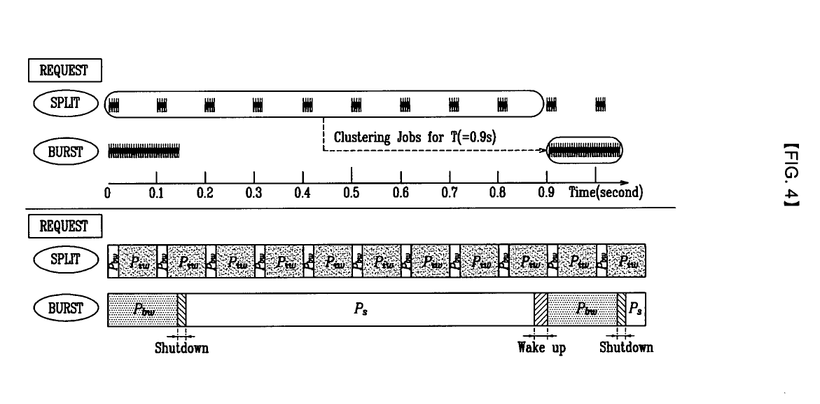

FIG. 4 illustrates frequency of wireless local area network (WLAN) calls and a power state thereof when a job is scheduled by a split scheduling method and is scheduled according to a burst period in which the job is transmitting output data of an H.263 encoder at 10 frames per second (fps) to a host personal computer (PC). Herein, the job is executed as soon as the job is generated according to the splitting scheduling method, whereas the jobs are queued and executed at a specific time according to the burst scheduling method.

As shown in FIG. 4, the WLAN is called every 0.1 seconds according to the split scheduling method, and this interval is shorter than a break-even time t_{be}| of the WLAN, which is 0.67. Therefore, it is not efficient to shut down the device based on the idle period even though the idle period is accurately predictable, as it would consume more power. On the other hand, the WLAN is called every 0.75 seconds according to the burst scheduling method, and accordingly, energy saving may be achieved by shutting down the device in this case.

Equations 2 to 4 calculate energy consumption of the WLAN during a burst period T according to the burst scheduling of FIG. 4.

$$\begin{matrix}{E}_{split} = \frac{T \times S \times N}{BW} \times {p}_{bw} + ( T - \frac{T \times S \times N}{BW} ) \times {p}_{iw} & ( 2 ) \\ {E}_{burst} = \frac{T \times S \times N}{BW} \times {p}_{bw} + ( T - \frac{T \times S \times N}{BW} - {t}_{0} ) \times {p}_{s} + {e}_{0} + {E}_{Buf} & ( 3 ) \\ {E}_{Buf} = \{ Integer ( \frac{S \times N}{nKbyte} ) + 1 \} \times T \times {p}_{nKbuf} & ( 4 )\end{matrix}$$

The first terms (Eₛₚₗᵢₜ, E_{burst}, and E_{buf}) in Equations 2 to 4 represent energy consumed for processing requests during T, respectively. The second term of Equation 2 represents energy consumed when the WLAN is maintained in the idle state without power management. The second term of Equation 3 represents energy consumed during a sleeping period, and e₀| represents state transition energy consumed for shutting down and waking up a device. At this point, the final term of Equation 3 may be calculated by Equation 4.

Herein,

$${E}_{Buf}$$

denotes energy consumed by a memory for buffering requests queued up for the burst scheduling. Therefore, a trade-off between the energy saved by the job scheduling and the energy consumed by the buffering is analyzed through Equation 2 and Equation 3. It may cost too much to implement a power control circuit when the size of a buffer is designed to be too small, but buffer capacity and energy may be inefficiently used when the size of the buffer is designed to be too large. Therefore, it is required to design the buffer with an appropriate reasonable size for power management.

The energy consumed for the split scheduling and burst scheduling, respectively, the size of a buffer that is appropriate for the burst scheduling, and a time constraint (deadline) of a task (or process) may be taken into account to determine optimal job scheduling for efficient power management, and they are calculated by the following relational expressions in Equations 5, 6, and 7. In the right side of the respective Equations 5, 6, and 7, constant values (lowercase) may be obtained from Table 2, and parameter values (uppercase) may be obtained from execution of tasks, characteristics of tasks, and an associated operating system (OS).

$$\begin{matrix}{T}_{eq} = \frac{{e}_{0} - {t}_{0} \times {p}_{s}}{{p}_{i} - {p}_{s}} \times \frac{1}{1 - \frac{N \times S}{BW}} ; {E}_{burst} = {E}_{split} & ( 5 ) \\ {T}_{buf} = \frac{BufferLimit}{S \times N} ; Memory constraint & ( 6 )\end{matrix}$$

T_{dl}=Deadline; Time constraint (7)

TABLE 2
Experimental results of characteristic
parameters of WLAN and DSP

Device

| Parameter | TM 1300 DSP | Orinoco WLAN |
|---|---|---|
| P_{iw} | 0.40 | 0.46 |
| Pₛ | 0.05 | 0.05 |
| P_{bw} | 0.44 | 0.65 |
| t₀ | 0.59 | 0.5 |
| e₀ | 0.17 | 0.3 |

For example, the following Equations 5′, 6′, and 7′ show results of substituting the values of the characteristic parameters of WLAN in <Table 2>, Bandwidth=5.5 Mbps, fps=10, Deadline=4, and Buffer Limit=1 MB to Equations 5, 6, and 7.

$$\begin{matrix}\begin{matrix}T = \frac{{e}_{0} - {t}_{0} \times {p}_{s}}{{p}_{i} - {p}_{s}} \times \frac{1}{1 - \frac{N \times S}{BW}} \\ = \frac{0.3 - 0.5 \times 0.05}{0.46 - 0.05} \times \frac{1}{1 - \frac{10 \times S}{5.5 Mbps}} \\ = 0.67 \times \frac{1}{1 - \frac{10 \times S}{720896}}\end{matrix} & ( {5}^{′} ) \\ \begin{matrix}T = \frac{BufferLimit}{S \times N} \\ = \frac{1 \times 1024 \times 1024}{S \times 10} \\ = \frac{104857.6}{S}\end{matrix} & ( {6}^{′} ) \\ T = Deadline = 4 & ( {7}^{′} )\end{matrix}$$

FIG. 4 is a graph showing results of Equations 5,′ 6′, and 7′. As shown therein, T is divided into region I, region II, and region III depending on a value of S.

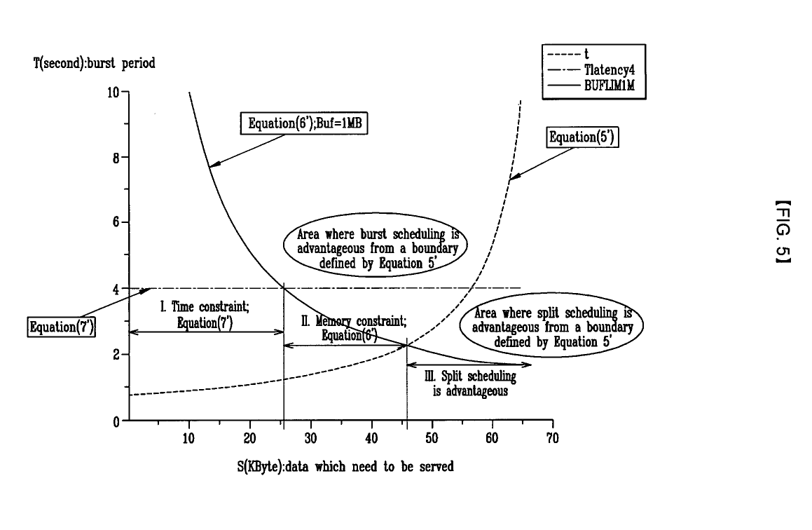

That is, an area of Equation 5′ in the graph of FIG. 5 represents a burst schedule period consuming an amount of energy equal to the amount of energy consumed for executing a job according to the split scheduling.

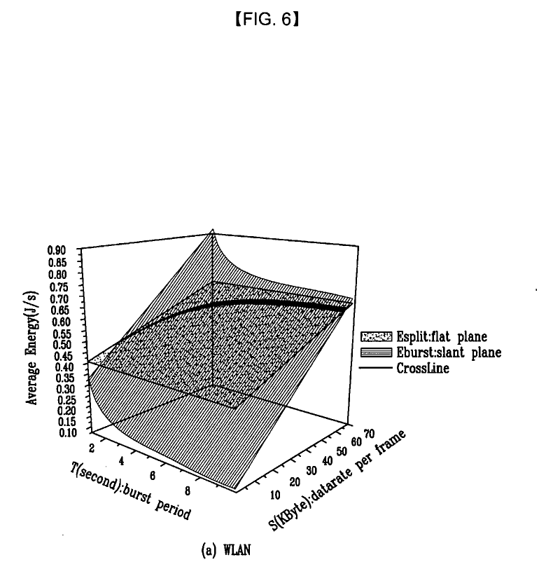

At this point, the burst scheduling method may be more advantageous than the splitting scheduling method for saving energy in the regions I and II at an top left side of Equation 5′. In the region III, however, the split scheduling method is more advantageous. This is determined by a cross-line of two planes respectively representing energy consumed for the split scheduling method and the burst scheduling method in the three-dimensional graph of FIG. 6. The graph of FIG. 6 represent values calculated by applying the characteristic parameter measurement of the WLAN, given bandwidth, time constraint (deadline), and memory size (buffer limit) to Equation 2 and Equation 3, and the cross-line is given by Equation 5.

An optimal burst period T for optimizing energy consumption in a region where the burst scheduling method is advantageous varies depending on a value of S determined by a current job.

In the case of the region I, an application program generates the value of S within a range of 0<S≦26 KB. At this point, the T may be infinite according to Equation 6′. However, since Equation 7′ defines a time constraint, the burst period cannot be longer than the time constraint, which is 4 seconds in this region.

Similar to the above, the application program sets the value of S within a range of 26 KB<S≦45.5 KB in the region II. The burst period T in this region may also be set to be 4 seconds due to the time constraint defined by the Equation 7′. However, the memory constraint may affect the optical burst period T at this time, and accordingly, the optimal burst period T is given by Equation 6′.

On the other hand, it is more advantageous to select the split scheduling method when the value of S is greater than 45.5 KB in order to save power, as previously mentioned, and accordingly the split scheduling method is selected in the region III such that a job for requesting WLAN is executed as soon as the job is generated.

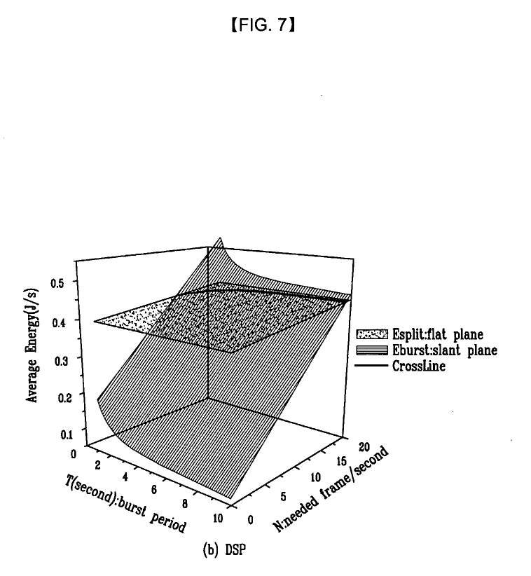

The above-described examples are also applied to a digital signal processor (DSP) with reference to estimates of characteristic parameters of a DSP in Table 2, Equations 5 to 7, and FIG. 7 illustrating energy consumed by the DSP for each scheduling. In the case of execution of a task (process) of the H.236 encoder using WLAN and a DSP, a job processing order is restricted, and thus a burst period T calculated for a first device works as a time constraint (deadline) of a second device to thereby obtain a burst period T of the second device.

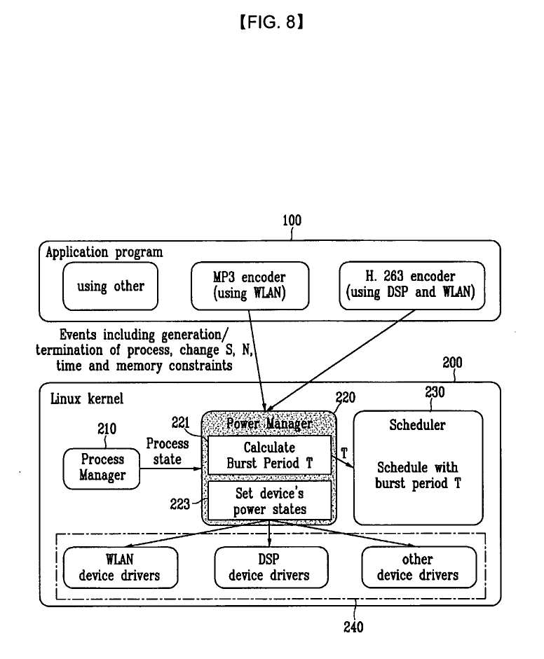

A platform according to an exemplary embodiment of the present invention will now be described in more detail with reference to FIG. 8.

The platform that manages power consumption by scheduling a job includes an application unit 100 and an operation system (OS) 200, wherein the job is defined as a set of instructions for completion of a specific task.

The application unit 100 is a module including programs implemented to perform a specific task. The programs include, for example, a MP3 encoder and an H.263 encoder, etc., and various application programs are included in the application unit 100.

The OS 200 including a process manager 210, a power manager 220, a scheduler 230, and a device driver 240 calculates an optimal burst period T on the basis of an event (i.e., an event of starting/terminating a specific task, changing S, N, modification of time and memory constraints) provided by the application unit 100, and schedules a job that uses each device in the platform according to the burst period T.

In more detail, the device driver 240 interacts with the devices included in the platform, and controls driving the devices with reference to information on the devices and a specific software interface. The device driver 240 includes drivers of the respective devices included in the platform. For example, the device driver may include a wireless local area network (WLAN) device driver 240 and a digital signal processor (DSP) driver 240.

When each task is generated, the process manager 210 receives information on generation of the task from the OS 200 (e.g., Linux kernel), and monitors and manages the current task. The process manager 210 then transmits information on a current state of the task to the power manager 220.

The scheduler 230 schedules jobs according to a calculated schedule period.

The power manager 220 including a T calculator 221 and a power state setting unit 223 calculates a job scheduling period and sets a power state of each device according to a job schedule.

In particular, when a predetermined event occurs, the T calculator 221 calculates a scheduling period T according to workloads based on a period when energy E̅ₛ̅ₚ̅ₗ̅ᵢ̅ₜ̅ consumed for split scheduling the job and energy E_{burst}| consumed for burst scheduling the job become equal, while considering a memory constraint and a time constrain, and determines an optimal period by selecting an appropriate job scheduling method. The calculator T 221 then transmits the selected scheduling method and the optimal period to the scheduler 230.

In more detail, the T calculator 221 selects the split scheduling method when the scheduling period in which the energy Eₛₚₗᵢₜ equals the energy E_{burst}| is equal to or greater than a first or second period. The first period is restricted by a memory constraint and the second period is restricted by a time constraint. When the scheduling period, calculated when the Eₛₚₗᵢₜ| and the energy E_{burst} become equal, is smaller than the first period or the second period, the T calculator 221 selects the burst scheduling method of a smaller period among the first and second periods.

The power state setting unit 223 sets a power state for each device using the device driver 240 according to task state information transmitted from the process manager 210 and a job schedule transmitted from the scheduler 230.

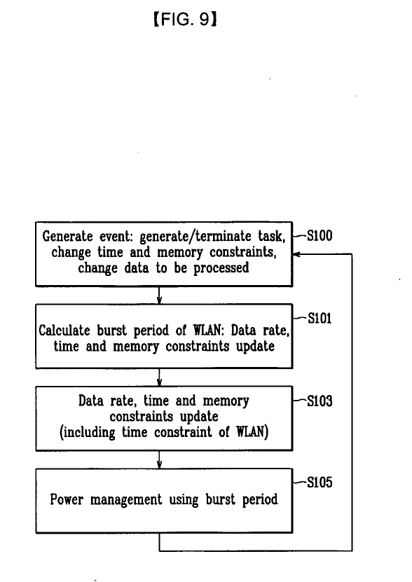

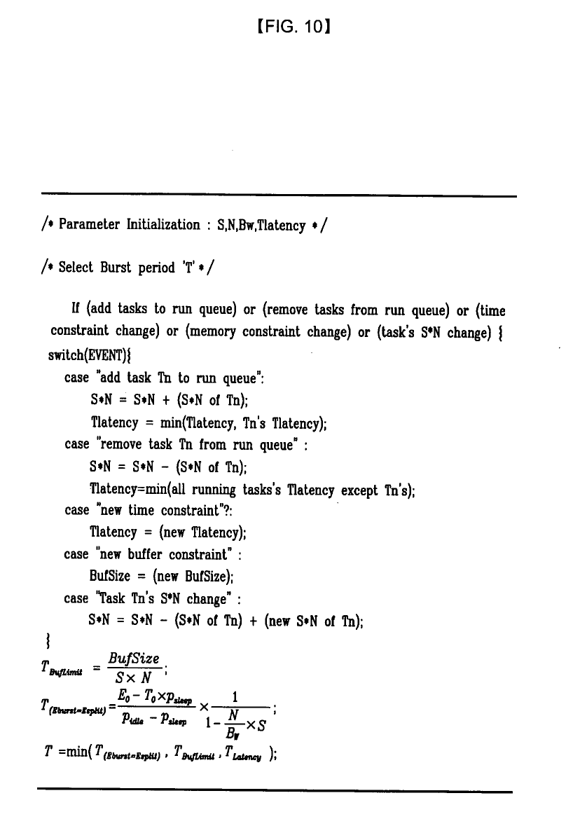

A method for power management of a platform according to an embodiment of the present invention will now be described with reference to FIG. 9 and FIG. 10.

When an event occurs, the occurrence of the event is informed from the application unit to the operating system in step S100. The event includes task generation/termination, modification of a memory constraint, modification of S and N, and modification of a time constraint, etc.

When a predetermined event occurs, the T calculator 221 calculates a scheduling period T according to workloads based on a period when energy Eₛₚₗᵢₜ| consumed for split scheduling the job and energy E_{burst} consumed for burst scheduling the job become equal, while considering a memory constraint and a time constrain, and determines an optimal period by selecting an appropriate job scheduling method.

At this moment, the T calculator 221 selects the split scheduling method when the schedule period during which the energy Eₛₚₗᵢₜ and the energy E_{burst}| become equal is equal to or greater than the first or second period as shown in FIG. 10. When the scheduling period is smaller than the first or second period, the T calculator 221 selects the burst scheduling method to determine an optimal scheduling period T for the job.

At this point, for example, the optical scheduling period for the job allocated to the WLAN is calculated first, and an optical scheduling period for another job allocated to another device in the platform (e.g., a DSP) is calculated in consideration of S*N, and time and memory constraints of the job. In this instance, the optimal scheduling period for the WLAN may affect the optimal scheduling period for the DSP as a time constraint, in steps S101 and S103.

The scheduler 230 schedules jobs in order to complete the jobs according to optimal scheduling periods of the respective devices, and the power state setting unit 223 changes power states of the respective devices according to the schedules for efficient power management in step S105.

The above described embodiment of the present invention may be applied to various devices in the platform, including the DSP and WLAN. When one power manager manages several devices, each device may require a buffer. In this instance, energy saving may be optimized by allocating buffers to each device in a rate of maximizing a sum of energy saved in each device.

The embodiments of the present invention may be utilized in a mobile platform, particularly, a robot. Since there is a limit to supplying a mobile device with power from a battery due to limited battery lifetime, it is important to design a device with longer battery lifetime and efficient power management. Therefore, when scheduling jobs using input/output (I/O) devices in an OS level of a robot according to the foregoing embodiments of the present invention, energy saving can be achieved since workloads of the jobs, the size of a memory for buffering the jobs, and time delay for the buffering are considered in the job scheduling, while minimizing degradation of system performance.

At this point, a power management method may be applied to a mobile platform in various steps depending on the currently available battery lifetime.

That is, a power management method generally causes degradation of system performance as much as achieving energy saving. Therefore, quality of service (QoS) is defined in consideration of the remaining battery capacity and different power management methods may be applied according to a power state.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for power management of a platform by scheduling a job given to a device, the job being a set of instructions for completion of a task, the method comprising:
a) when a given event occurs, analyzing the event according to workloads;
b) calculating a scheduling period T of a job to be performed on the corresponding device in consideration of at least one of a time constraint, the size of a memory for buffering the job, and energy consumed for the buffering according to workloads of the job; and
c) controlling a power state of each device according to the scheduling period of the job calculated in b).

2. The method of claim 1, wherein in b), the scheduling period is calculated in consideration of at least one of a first period which is restricted by the memory size and a second period which is restricted by the time constraint.

3. The method of claim 2, wherein in b), one of the first and second periods is considered as a constraint on determination of an optimal scheduling period according to variations of workloads.

4. The method of claim 3, wherein in b), the calculating of the scheduling period T comprises considering one of the first or second periods as a constraint, based on a scheduling period during which the amount of energy Eₛₚₗᵢₜ consumed for split scheduling the job and the amount of energy E_{burst} consumed for burst scheduling the job become equal.

5. The method of claim 4, wherein in b), split scheduling is selected when a scheduling period during which the amount of energy Eₛₚₗᵢₜ consumed for split scheduling the job and the amount of energy E_{burst} for burst scheduling the job become equal is equal to or greater than the first or second period.

6. The method of claim 4, wherein in b), burst scheduling according to a smaller one among the first and second periods is selected when a scheduling period during which the amount of energy consumed for split scheduling the job and the amount of energy consumed for burst scheduling the job become equal is smaller than the first or second period.

7. The method of claim 4, wherein a period during which
$${E}_{split}$$
and E_{burst}| become equal corresponds to a scheduling period T derived from the equation Eₛₚₗᵢₜ=E_{burst}, and Eₛₚₗᵢₜ and E_{burst}| are respectively obtained from
$$\begin{matrix}{E}_{split} = \frac{T \times S \times N}{BW} \times {p}_{bw} + ( T - \frac{T \times S \times N}{BW} ) \times {p}_{iw} \\ {E}_{burst} = \frac{T \times S \times N}{BW} \times {p}_{bw} + ( T - \frac{T \times S \times N}{BW} - {t}_{0} ) \times {p}_{s} + {e}_{0} + {E}_{Buf} \\ {E}_{Buf} = \{ Integer ( \frac{S \times N}{nKbyte} ) + 1 \} \times T \times {p}_{nKbuf}\end{matrix}$$
(S: size of data to be processed, N: number of requests for task),
e̅ₒ̅: power state transition energy,
$${t}_{o} \text{:}$$
power state transition delay time,
BW: data processing performance of device (bps, fps, etc.),
P_{bw}|: power consumption in the busy working state of device,
$${P}_{iw} \text{:}$$
Piw: power consumption in the idle working state of device,
$${P}_{S} \text{:}$$
Pₛ: power consumption in the sleeping state of device, and
$${P}_{nKbuf} \text{:}$$
PnKbuf: power consumption of n Kbyte buffer memory).

8. The method of claim 4, wherein the period when
$${E}_{split} \text{:}$$
equals
$${E}_{burst} \text{:}$$
is
$${T}_{eq} = \frac{{e}_{0} - {t}_{0} \times {p}_{s}}{{p}_{i} - {p}_{s}} \times \frac{1}{1 - \frac{N \times S}{BW}}$$
(S: size of data to be processed, N: number of requests for task,
eₒ: power state transition energy, tₒ|: power state transition delay time,
BW: data processing performance of devices (bps, fps, etc.),
$${P}_{i} \text{:}$$
Pi: power consumption in idle working state of device, and
$${P}_{S} \text{:}$$
Ps: power consumption in sleeping state of device).

9. The method of claim 2, wherein the first period is obtained from the following equation:
$${T}_{buf} = \frac{Buffer Limit}{S \times N}$$
(S: size of data to be processed, N: number of requests for task).

10. The method of claim 1, wherein the size of the memory corresponds to the size of a memory when the amount of energy consumed for buffering requests according to burst scheduling is less than the amount of energy saved by the burst scheduling.

11. The method of claim 1, wherein an optimal scheduling period T of a first device, which is calculated in advance, is considered as the time constraint on calculation of the optimal scheduling period T of a second device.

12. The method of claim 1, wherein the given event comprises at least one of generation of the job, termination of the job, changing the size of memory, changing the time constraint, changing the number (N) of requests for task, and changing the size (S) of data to be processed.

13. The method of claim 12, wherein the workload is determined by the size (S) of data to be processed and the number (N) of requests for a task.

14. A platform managing power consumption by scheduling a job, which is a set of instructions allocated to a device for completion of a task, the platform comprising:
an application unit generating a given event; and
an operating system obtaining an optimal scheduling period T in consideration of at least one of a time constraint, a memory size, and energy consumed for buffering according to workloads of the job, and controlling a power state of the corresponding device when receiving information on the generation of the event.

15. The platform of claim 14, wherein the operating system comprises:
a process manager for receiving information on generation of a task, monitoring and managing a current task, and transmitting information on a task state;
a scheduler for scheduling the job according to a scheduled period;
a device driver for controlling driving of a device by which the job is executed; and
a power manager for obtaining an optimal scheduling period in consideration of at least one of a time constraint, a memory size, and energy consumed for the buffering according to workloads, and controlling the device driver to control a power state of the corresponding device based on information on a task state transmitted from the process manager and a job schedule transmitted from the scheduler.

16. The platform of claim 15, wherein the power manager comprises:
a T calculator calculating an optimal scheduling period T in consideration of at least one of a first period restricted by the memory size and a second period restricted by the time constraint, and transmitting the optimal scheduling period T to the scheduler; and
a power state setting unit controlling the device driver to control a power state of the corresponding device based on the information on the task state transmitted from the process manager and the job schedule transmitted from the scheduler.

17. The platform of claim 16, wherein the T calculator considers one of the first and second periods as a constraint on determination of an optimal scheduling period T.

18. The platform of claim 17, wherein the T calculator selects split scheduling when a scheduled period during which the amount of energy Eₛₚₗᵢₜ consumed for split scheduling the job and the amount of energy E_{burst} consumed for burst scheduling the job are equal is equal to or greater than the first or second period.

19. The platform of claim 17, wherein the T calculator selects burst scheduling according to a smaller one among the first period and the second period when a scheduled period during which the amount of energy Eₛₚₗᵢₜ consumed for split scheduling the job and the amount of energy E_{burst} consumed for burst scheduling the job are equal is smaller than the first period or the second period.

20. The platform of claim 16, wherein a period when Eₛₚₗᵢₜ equals
$${E}_{burst}$$
Eburst is derived from a schedule period calculated by the equation
$${E}_{split}$$
=E_{burst}|, and Eₛₚₗᵢₜ| and E_{burst}| are respectively calculated by the following equations:
$$\begin{matrix}{E}_{split} = \frac{T \times S \times N}{BW} \times {p}_{bw} + ( T - \frac{T \times S \times N}{BW} ) \times {p}_{iw} \\ {E}_{burst} = \frac{T \times S \times N}{BW} \times {p}_{bw} + ( T - \frac{T \times S \times N}{BW} - {t}_{0} ) \times {p}_{s} + {e}_{0} + {E}_{Buf} \\ {E}_{Buf} = \{ Integer ( \frac{S \times N}{nKbyte} ) + 1 \} \times T \times {p}_{nKbuf}\end{matrix}$$
(S: size of data to be processed, N: number of requests for task,
ēₒ: power state transition energy,
$${t}_{o} \text{:}$$
to: power state transition delay time,
BW: data processing performance of device (bps, fps, etc.),
P_{bw}|: power consumption in busy working state of device,
P_{iw}|: power consumption in idle working state of device,
Pₛ|: power consumption in sleeping state of device, and
P_{nKbul}|: power consumption for n Kbyte buffer memory).

21. The platform of claim 16, wherein a period when Eₛₚₗᵢₜ equals E_{burst}| is calculated by the following equation:
$${T}_{eq} = \frac{{e}_{0} - {t}_{0} \times {p}_{s}}{{p}_{i} - {p}_{s}} \times \frac{1}{1 - \frac{N \times S}{BW}}$$
(S: size of data to be processed, N: number of requests for task,
eₒ: power state transition energy, tₒ|: power state transition delay time,
BW: data processing performance of device (bps, fps, etc.),
Pᵢ|: power consumption in idle working state of device, and
Pₛ: power consumption in sleeping state of device).

22. The platform of claim 16, wherein the first period is calculated from the following equation:
$${T}_{buf} = \frac{Buffer Limit}{S \times N}$$
(S: size of data to be processed, N: number of requests for task).

23. The platform of claim 14, wherein the T calculator considers an optimal scheduling period T for a first device, which is calculated in advance, as a time constraint on calculation of an optimal scheduling period T for a second device.

24. The platform of claim 14, wherein capacity of the memory corresponds to capacity of a memory when the amount of energy consumed for buffering requests according to burst scheduling is less than the amount of energy saved by the burst scheduling.

25. The platform of claim 14, wherein the given event comprises at least one of generation of the job, termination of the job, modification of the time constraint, modification of the memory constraint, energy consumed for buffering according to workloads of the job and modification of a power state of the corresponding device.

26. The platform of claim 25, wherein the job scheduling is determined by the number (N) of requests for task and the size (S) of data to be processed.
